(19) United States
(12) Patent Application Publication
(10) Pub. No.: US 2003/0099917 A1
(43) Pub. Date: May 29, 2003

(54) Piezoelectric dental scaler apparatus

(75) Inventor: Jan Wietecha, Bothell, WA (US)

Correspondence Address: James R. Vance, 24422 SE 46th Court, Issaquah, WA, 98029, US

(73) Assignee: Aseptico, Incorporated, a Division of North Pacific Dental

(21) Appl. No.: 09/997,320

(22) Filed: Nov. 26, 2001

(51) Int. Cl. A61C 3/03

(52) U.S. Cl. 433/119

(57) ABSTRACT

Electrically-powered, hand-held, piezoelectric, dental scaler apparatus for its manufacture and use, wherein the apparatus includes a handle assembly having an elongated shaft passing through a bore within an inertial resistant mass, and one or more piezoelectric ceramic discs juxtaposed between the elongated shaft and the inertial resistant mass.

### COPYRIGHT NOTICE

© Copyright 2001 James R. Vance. All rights reserved.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNICAL FIELD

This invention relates to electrically-powered, piezoelectric, dental scaler hand pieces generally used within the dental and medical professions. More particularly, this invention relates to apparatus that permit a dentist, doctor, surgeon or other person to abrade, cut and/or sculpt tooth, bone, tissue or other material using a working top of an oscillating tool, such as a scaler or other instrument, that selectively oscillates within a variable, selectable, maximum or limited stroke.

### BACKGROUND ART

An electrically-powered, piezoelectric dental scaler is an instrument composed of a handle assembly and an electric control module. The handle assembly encloses a segmented bar and one or more piezoelectric ceramic discs or disks. The segmented bar has a front mass portion and a rear or back mass portion.

A distal end of the front mass removably holds and retains a replaceable scaler tip or end tool. The back mass is a relatively massive segment of steel which is resistant to changes in inertia. In comparison, the front mass is much more influenced by changes in inertia than is the back mass. The combined front mass and back mass define the segmented bar.

Placed intermediate between the front mass and the back mass are a plurality of piezoelectric ceramic discs which are operatively connected to the electric control module and an electrical power source. Within the prior art, the back mass is provided with a very small protrusion thereof which passes through centralized bore holes located within the piezoelectric ceramic discs and is mechanically and tightly secured to the front mass. The discs are, in essence, juxtaposed between the front mass and the majority of the back mass with a very small portion of the back mass passing through the centralized bore hole within each ceramic disc. The front mass and the back mass are connected so as to place the intermediate discs in great compression.

When connected to an oscillating electrical charge, the piezoelectric discs can be manipulated to expand and contract in an oscillating manner at very high frequencies. The oscillating expansion and contraction of the piezoelectric discs can, in turn, be used to drive or oscillate a sharp tip of an attached dental scaling tool.

More particularly, when an electrical charge is applied to the piezoelectric ceramic discs, such discs expand beyond their original dimensions. When the discs are thus charged and expanded, the segment of the back mass which is located within the centralized bore holes of the discs is forcefully elongated. Since the mass or weight of the back mass is much greater than the mass or weight of the front mass, the front mass and the accompanying scaler tool are forced forward when the electrical charge is thus applied.

Conversely, when the electrical charge is removed from the discs, the discs contract to their original dimensions which permit the segment of the back mass located within the centralized bore holes of the discs to also retract in response thereto. Since the mass or weight of the back mass is much greater than the mass or weight of the front mass, the front mass and the accompanying scaler tool are forced rearwardly when the electrical charge is removed.

By rapidly alternating the application and removal of the electrical charge, the front mass and its attached scaler tool may be forced to vibrate or oscillate back and forth along their longitudinal length. When a sharp tip of the scaler tool is placed adjacent to and against a dental surface, this oscillating back and forth movement may be beneficially used to: remove dental calculus, scale, tartar or other undesirable material from the tooth; debride tissue; correct tissue abnormalities; and/or perform other dental surgeries or operations.

The following disclosures relate to various known types of piezoelectric dental scaler devices: Banko (U.S. Pat. No. 3,930,173; issued Dec. 30, 1975); Hatter et al. (U.S. Pat. No. 4,176,454; issued Dec. 4, 1979); Wuchinich (U.S. Pat. No. 4,425,115; issued Jan. 10, 1984); Idemoto et al.(U.S. Pat. No. 4,832,683; issued May 23, 1989); Hetzel (U.S. Pat. No. 5,059,122; issued Oct. 22, 1991); DiMatteo et al. (U.S. Pat. No. 6,051,010; issued Apr. 18, 2000); and Sharp (U.S. Pat. No. 6,190,167 B1; issued Feb. 20, 2001).

Many of the devices listed above have significant disadvantages. For example, many such devices are very expensive to design, engineer, manufacture, produce and distribute.

The relatively expensive piezoelectric discs are very easily damaged during installation, transportation, use and storage. Such damage requires dismantling of the hand piece, replacement of the discs, and reassembly of the hand piece. This is not only costly in parts and manpower, but is inconvenient and frustrating to both the operator and the patient. Furthermore, if a delicate and time crucial operation is being performed, the liability of the operator and risk to the patient might be increased.

In addition, the effectiveness of many of the listed devices is much less than desirable. For example, only an extremely small or short length of the inertia-resistant back mass is stretched or elongated when the ceramic discs are electrified. Consequently, such hand-held, piezoelectric dental scalers are structured to provide only very limited oscillating strokes. In essence, the elongation is limited to only that portion of the back mass which is located within the centralized bore holes of the ceramic discs. This small segment of steel easily becomes subject to fatigue failure when the device is used for a long period of time. Furthermore, since only a very short length of the back mass is being elongated, the efficiency of the oscillation is also impaired.

In addition, the inertia-resistant back mass is mechanically secured to the front mass. This is accomplished by rotating and threading the back mass into a corresponding threaded bore hole located within the front mass, the ceramic discs are not only compressed but are also subjected to shear forces. As a result, the thin and expensive ceramic discs are very easily, readily and commonly fractured and broken.

The inventor believes that the above-cited devices and patents, whether taken alone or in combination, neither anticipate nor render obvious the current invention. The foregoing explanation and citations do not constitute an admission that such devices or patents are relevant or material to the appended patent claims. Rather, such devices and patents relate only to the general field of the current invention.

### DISCLOSURE OF INVENTION

This invention may be used by licensed dentists, doctors, surgeons, dental hygienists, assistants or any other person with the proper governmental authorization.

This invention provides simple, safe, effective, easily used apparatus for: removing dental calculus, scale, tartar and other undesirable materials from a tooth; debriding tissue; correcting tissue abnormalities; and performing other surgeries and dental operations.

The apparatus is relatively inexpensive and economical to manufacture, easily constructed, rugged and much more efficient than devices heretofore known. The complexity of the apparatus is greatly reduced, when compared to the complexity of many of the prior known devices.

Once manufactured, the apparatus requires only a minimum amount of manipulation, physical dexterity and effort to use, service and maintain.

The apparatus of this invention provides a dramatic increase in the reliability, durability and longevity of the piezoelectric ceramic discs used within the scaler apparatus.

Other important and particularly beneficial features of this invention include: (a) the ability to modify or adjust the length and associated force of the oscillating stroke of the apparatus; (b) minimize the number, thickness and bulkiness of components used within the apparatus; (c) eliminate or greatly reduce the need to replace the piezoelectric ceramic discs once they are initially installed within the apparatus; and (d) permit the use of different types of materials to be used within the hand piece or handle assembly, and, more particularly, between the front mass portion of the segmented bar and the inertia-resistant back mass portion thereof.

Traditional and nontraditional manufacturing apparatus and procedures may be used to manufacture the current invention without requiring significant alteration thereto to accomplish the purposes taught herein.

Traditional and nontraditional tools and instruments may be attached to the working distal end of the front mass portion of the segmented bar.

Traditional and nontraditional means for powering the apparatus may also be used.

In addition to having the foregoing advantages and other advantages described below, the current invention also overcomes most if not all of the previously mentioned disadvantages.

To accomplish these objectives, the apparatus of this invention includes significant modifications and improvements to the segmented bar of the handle assembly, and particularly to the inertia-resistant back mass portion thereof. What would otherwise have been a conventional unitary back mass portion is now divided into two (2) or three (3) distinct sub-parts.

For example, within the first embodiment of this invention, the back mass portion is provided with an elongated shaft member that is substantially longer than the combined width of the ceramic discs. In essence the stress and strain exerted on the elongated shaft member is now distributed over a significantly longer length than was previously imposed upon the heretofore short length of metal that was only equal to the combined width of the ceramic discs.

Within the second embodiment of this invention, the back mass portion comprises three (3) separate and different components, namely, (a) a centralized, elongated, tensile bolt, (b) a generally hollow cylindrical tube which receives the tensile bolt and is used as an inertia resistant back mass, and (c) a rearwardly positioned compression nut attached to the tensile bolt.

Within this invention, the tensile bolt can be manufactured from a material that is chemically, structurally and/or characteristically different from the material used in the manufacture of the inertia-resistant back mass. For example, the tensile bolt may be manufactured from titanium having high tensile strength, whereas the cylindrical tube or back mass may be manufactured of a heavier or denser steel, lead or other metal material.

A forward, leading and distal end of the tensile bolt is mechanically secured to the front mass.

A rearward, trailing and proximal end of the tensile bolt passes through the centralized bore hole located within each the ceramic discs and then passes through a central core opening or bore hole located along the entire length, or at least a substantial portion of the length, of the back mass. A terminal portion of the rearward or trailing end of the tensile bolt is further built to receive a mated compression nut.

Please note that rotation of the compression nut onto the mated rearward or trailing end of the tensile bolt does not exert any significant shear forces or torsional forces upon the ceramic discs which are juxtaposed between the front mass and the back mass. Rather, only compression forces are primarily applied to the discs, juxtaposing the discs tightly between the front mass and the modified rear mass. Consequently, the fragile ceramic discs are not as easily fractured or broken.

One of the greatest benefits of this invention is that the stretching or elongation of the tensile bolt, caused by the expansion of the electrified discs, is distributed along nearly the entire length of the tensile bolt, or at least along that portion of the tensile bolt which spans between the front mass and the rear compression bolt. For example, such compression forces can now be distributed over a length of approximately one to two inches (1″-2″) or more, instead of only less than one-half of an inch (½″) as found within the previously known devices.

Since such compression and retraction forces are distributed over a much greater length (and possibly of a different type of material), problems of metal fatigue are eliminated and the efficiency of the overall mechanical system is dramatically increased.

In other words, the expansion, stretching and elongation of the tensile bolt is distributed along nearly the entire length of the bolt, and more mechanical power or force is transmitted to the tip of the working tool than could otherwise be obtained. Consequently, there is better power transmission transmitted to the tip of the working tool.

As stated above, the cylindrical tube or inertia resistant back mass preferably has a centrally positioned bore hole that passes through the entire longitudinal length thereof. The bore hole within the back mass is sized so as to accommodate the passage of the compression bolt there through, without significant frictional resistance or shear forces being applied to the tensile bolt within the bore hole itself. Consequently, nearly the entire length of the tensile bolt may be utilized to absorb and transmit the expansive and retractive forces of the ceramic discs as they are electrified and permitted to assume an original unelectrified state.

Of course, when the tensile bolt is under tension, the cylindrical tube or inertia resistant back mass resists such forces and is compressed.

To appropriately transmit such compressive forces to the back mass, a compression nut is operatively secured to the rearward terminal end of the tensile bolt.

Alternatively, an effective compression nut may be incorporated into the structure of the back mass near the rearward-most opening of the bore hole located within the back mass. In other words, a portion of the bore hole furthest the working tip of the tool may have a smaller diameter and be provided with threads therein into which a portion near the rearward terminal end of the tensile bolt may be secured.

Of course, other means for securing the rearward most terminal end of the tensile bolt to the back mass may be provided. For example, a cam lever, clamp, clip, pin, or other securing structure could be used instead of a compression nut. However, the use of a compression nut is currently the preferred manner for carrying out this invention.

The preferred and several alternative embodiments of the apparatus and associated structures of the current invention are further described in greater detail in the following description, claims, and accompanying drawings of this Specification. However, to avoid any possible confusion as to the scope of the current invention, each of the following sections, claim language, and drawings of this Specification in their entirety are incorporated herein by this reference.

The foregoing and other objectives and advantages of the current invention will become more readily apparent upon reading the following disclosure and referring to the attached drawings.

### BRIEF DESCRIPTION OF DRAWINGS

FIG. 1 is a schematic, partial, cross-sectional, side-elevational view of a first embodiment of this invention, illustrating how various external housing components and various internal operational components of the first embodiment can be constructed and joined together to accomplish the objectives taught herein. Such external housing components and internal operational components are contained within and form a part of a handle assembly. This cross-section is viewed from a plane defined by line I-I in FIG. 2.

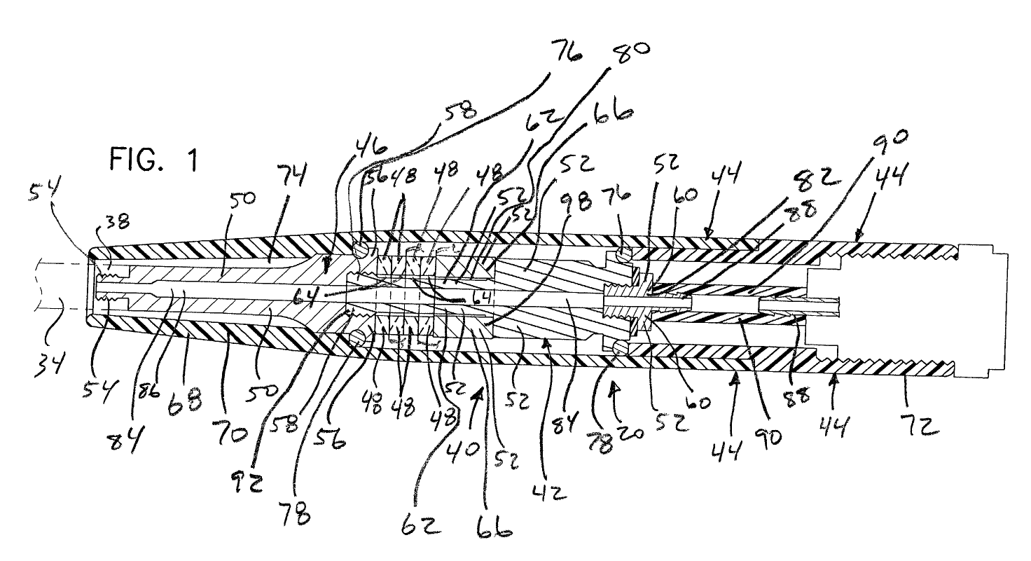

Since the apparatus of this invention is used with conventional electrical control devices, which are readily available on the open market, such electrical control devices are not shown within the accompanying drawings. In other words, the operative handle assemblies or hand pieces illustrated herein are depicted as being removed from their corresponding electrical control devices.

FIG. 2 is a schematic, partial, fragmentary, isometric or perspective view of the external housing components and the internal operational components which define the handle assembly of the first embodiment of this invention, as shown within FIG. 1. Please note that a working articulated scaler tool or other representative instrument is secured to a distal end of the handle assembly, and the external housing components are shown using phantom lines.

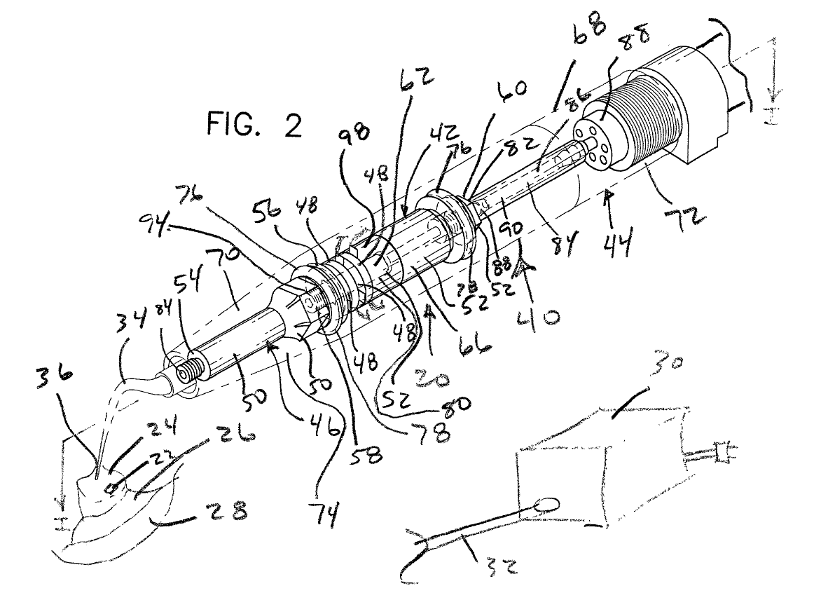

FIG. 3 is a schematic, partial, exploded, isometric or perspective view of the various internal operational components of the first embodiment of this invention, as illustrated within FIGS. 1 and 2.

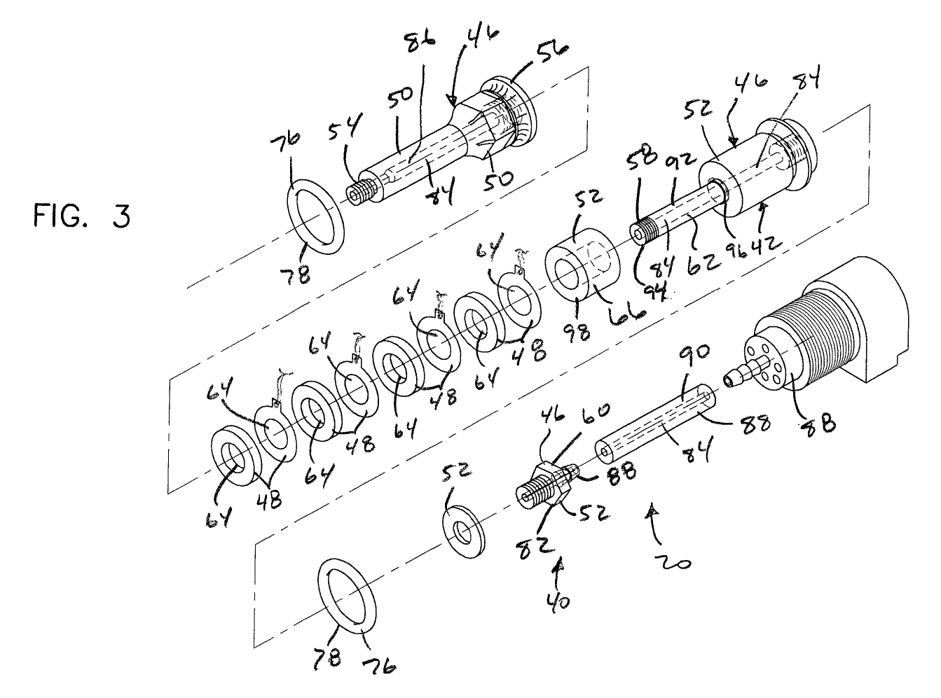

FIG. 4 is an enlarged, schematic, partial, cross-sectional, side-elevational view of a second embodiment of this invention, illustrating how various alternative external housing components and various alternative internal operational components can be joined together to also accomplish the same objectives. Again, the external housing components and internal operational components are contained within and form a part of a handle assembly, albeit a second embodiment thereof. This cross-section of the internal operational components is viewed from a plane defined by line IV-IV in FIG. 6.

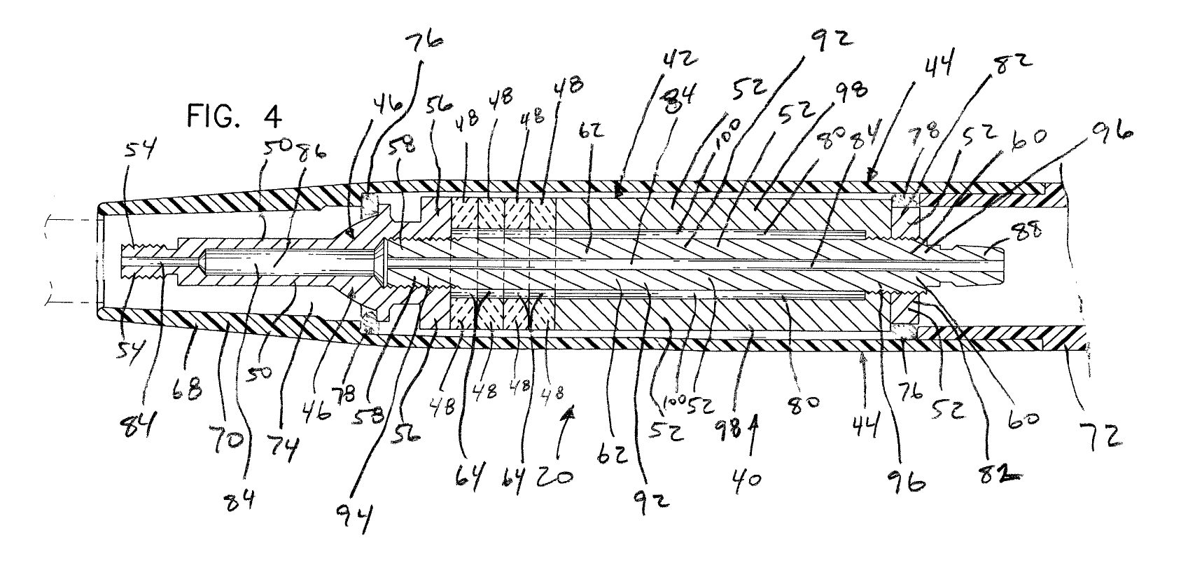

FIG. 5 is a schematic, partial, exploded, isometric or perspective view of the internal operational components of the second embodiment of this invention as illustrated within FIG. 4.

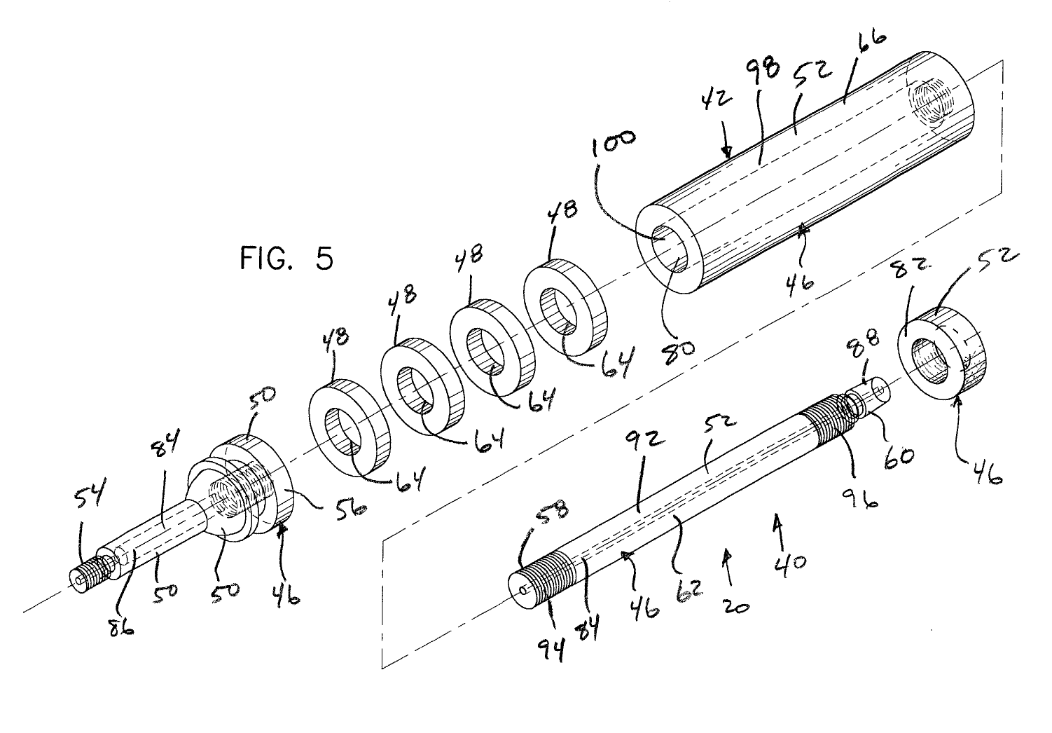

FIG. 6 is a schematic, partial, isometric or perspective view of the joined internal operational components of the second embodiment shown in FIGS. 4 and 5. For purposes of clarity, the external housing components of the second embodiment are omitted from the drawing in FIG. 6.

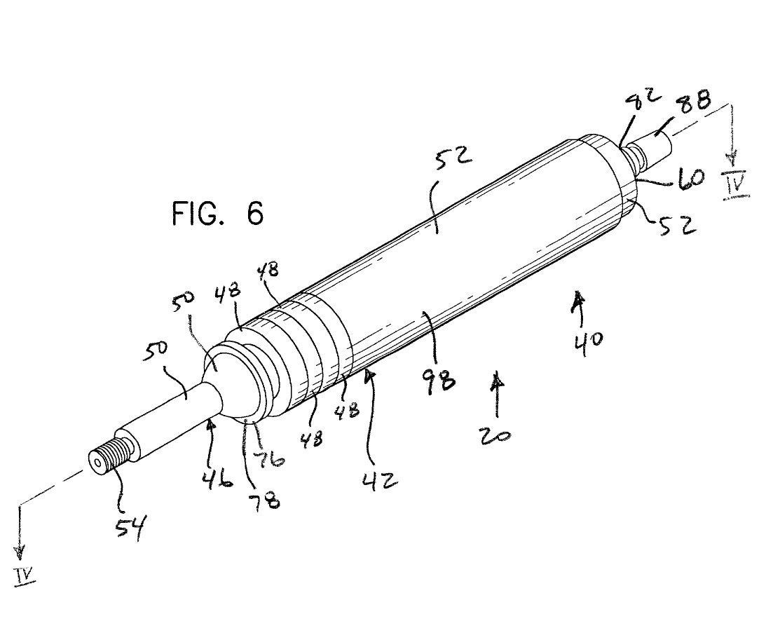

One should understand that the drawings are not necessarily to scale and the elements are sometimes illustrated by graphic symbols, phantom lines, diagrammatic representations and fragmentary views. In certain instances, the inventor may have omitted details which are not necessary for an understanding of the current invention or which render other details difficult to perceive.

### BEST MODE FOR CARRYING OUT THE INVENTION

Referring to the attached drawings, wherein like numerals indicate like parts, the current invention generally comprises an improved, electrically-powered, hand-held, piezoelectric dental scaler apparatus 20 for removing dental calculus, scale, tartar or undesirable material 22, debriding, abrading, cutting, sculpting or correcting abnormalities, or performing surgical or dental operations on a tooth 24, bone 26 or tissue 28.

The apparatus 20 is capable of being operatively connected to an electric control module or device 30 which can provide selective oscillating electrical charges 32 to the apparatus 20. The apparatus 20 is capable of being operatively connected to a removable scaler tool or other instrument 34 which has a tip 36 and a tool coupling end 38.

The apparatus 20 generally comprises: an operative handle assembly 40 which defines a hand piece. The handle assembly 40 has internal operational components 42 and external housing components 44.

The internal operational components 42 are generally defined by (a) a segmented bar 46 or tube, and (b) one or more piezoelectric ceramic discs 48 or disks.

The segmented bar 46 has a front mass portion 50 and a rear or back mass portion 52. The front mass portion 50 has a distal end 54 to which the coupling end 38 of the removable scaler tool or other instrument 34 may be removably attached. The front mass portion 50 also has an opposed proximal end 56.

It is important to note that the back mass portion 52 has an inertia resistance that is greater than an inertia resistance of the front mass 50. Because of this, when the ceramic discs 48 are exposed to the oscillating charge 32 and are caused to expand and relax or contract pursuant to such oscillations, the back mass portion 52 is more resistant to such ultrasonic and high frequency vibrations. Consequently, such energies are primarily focused and directed toward the front mass portion 50 and its attached instrument 34. This feature will be discussed in greater detail below. For now, the various elements and components of the apparatus 20 will be introduced.

The back mass portion 52 has a first end 58 which is capable of being operatively and removably secured to the proximal end 56 of the front mass portion 50. The back mass portion 52 also has an opposed second end 60.

The back mass portion 52 has an elongated shaft member 62 which is generally positioned intermediate between the first end 58 and the second end 60.

As mentioned above, one or more of the piezoelectric ceramic discs 48 or disks are capable of being operatively connected to the electric control module or device 30, and to the oscillating electrical charge 32 thereof. The ceramic discs 48 are capable of expanding and contracting, or at least returning to a latent non-electrically charged state, with each oscillation of the oscillating electrical charge 32. Consequently, the ceramic discs 48 expand and contract in an oscillating manner with a variable, selectable, maximum or limited stroke when they are operatively connected to the oscillating electrical charge 32. The resulting ultrasonic or high frequency vibration can now be used beneficially to transmit vibration through the handle assembly 40 to the tip 36 of the instrument 34.

To accomplish this task, the ceramic discs 48 are juxtaposed between the front mass portion 50 and at least a portion of the back mass portion 52. Within the preferred embodiment of this invention, each ceramic disc 48 is provided with a bore hole 64 centrally positioned therein through which the elongated shaft member 62 of the back mass portion 52 may be inserted.

This next feature is very important to understand. The elongated shaft member 62 of the back mass portion 52 has a length which is capable of being stretched and further elongated with the expansion and contraction or relaxation of the ceramic discs 48. However, such length of the elongated shaft member 62 is substantially longer than a combined thickness of the ceramic discs 48. Consequently, the stress and strain that is placed upon the elongated shaft member 62 during operation of the apparatus 20 is distributed over a much longer length and greater amount of material than was previously available. Metal fatigue is eliminated. More power is available to the tip 36. The full length of stroke can be used, rather than dissipated in an effort to force too small of a length of material to move.

In order to provide an elongated shaft member 62 and not require the use of an inordinate number of expensive ceramic discs 48, within the first embodiment of this invention, a spacer 66 is positioned between the ceramic discs 48 and either the back mass portion 52 or the front mass portion 50. Thus structured, the substantial length of the elongated shaft member 62 may be accommodated and a reasonable number of ceramic discs 48 may be used.

Operative attachment of the back mass portion 52 to the front mass portion 50 causes the ceramic discs 48 to be compressed between the spacer 66 and the front mass portion 50. Alternatively, the ceramic discs 48 may be compressed between the spacer 66 and the back mass portion 52.

The external housing components 44 generally include a segmented handle 68 which has a front portion 70 and a rear portion 72. The front portion 70 and the rear portion 72 are capable of being joined together or separated. The handle 68 also has a cavity or compartment 74 therein. The compartment 74 is of sufficient size and structure to accommodate placement of the internal operational components 42 therein.

The handle 68 may also include means 76 for insulating at least a portion of the vibrations of the internal operational components 42 from being transmitted to a hand of an operator. For example, the vibration insulating means 76 may comprise one or more rubber or synthetic washers 78, gaskets or spacers that both centralize the internal operational components within the compartment 74 and absorb vibrations therefrom.

Within the second embodiment of this invention, the back mass portion 52 is provided with a bore hole 80 therein through which a separate and distinct elongated shaft member 62 may pass. The back mass portion 52 further includes a compression nut 82. Operative attachment of the compression nut 82 to the elongated shaft member 62 at or near the second end 60 of the back mass portion 50 enables the ceramic discs 48 to be compressed between at least a portion of the back mass portion 52 and the front mass portion 50. Thus structured, expansion, stretching and elongation of the elongated shaft member 62 can be distributed along a length that generally spans between the proximal end 56 of the front mass portion 50 and contact with the compression nut 82.

Within each of these described embodiments, it is preferable that the front mass portion 50 and the back mass portion 52 of the segmented bar 46 are provided with aligned, co-linear, longitudinal suction or application bore holes 84 therein through which a fluid or gas 86 may pass. Coupling means 88 and rubber or plastic hoses 90 may be provided to accomplish these objectives.

Within the second embodiment of this invention, the elongated shaft member 62 generally comprises a tensile bolt 92 or tube. A forward, leading and distal end 94 of the tensile bolt is mechanically secured to or near the proximal end 56 of the front mass portion 50.

The tensile bolt 92 has a terminal, rearward or trailing end 96 which can be threaded to received a mated and threaded compression nut 82. The compression nut 82 is thus removably secured to the rearward end 96 of the tensile bolt 92. Rotation of the compression nut 82 onto the rearward end 96 of the tensile bolt 92 primarily exerts compression forces and little or no shear or torsional forces upon the ceramic discs 48, thus eliminating or greatly reducing the chances of breaking the ceramic disc 48 during installation and maintenance.

To accommodate the use of as long as possible elongated shaft member 62 or tensile bolt 92, within limits of overall weight and acceptable sizes for the handle assembly 40, the back mass portion 52 is provided with and is further defined by the use of a hollow cylindrical tube 98 or member which has a bore hole 100 or core opening located along an entire length thereof. The bore hole 100 is capable of receiving the tensile bolt 92. In essence, the rearward, trailing or proximal end 96 of the tensile bolt 92 passes through the bore hole 100 or core opening and protrudes therefrom, which enables the compression nut 82 to be secured to the tensile bolt 92.

Thus structured, the hollow cylindrical tube 98 generally defines a heavy, inertia resistant back mass, which defines a majority of the weight of the back mass portion 52.

The tensile bolt 92 may be manufactured from a material that is chemically, structurally and/or characteristically different from the material which used in manufacture of the hollow cylindrical tube 98. For example, the tensile bolt 92 may be manufactured from titanium or a titanium alloy. Whereas, the hollow cylindrical tube 98 of the back mass portion 52 may be manufactured from a substantially heavier and/or denser material, such as from steel, iron, stainless-steel or other desirable materials.

As mentioned previously above, preferably, the elongated shaft member 62 is centrally positioned within the handle assembly 40. This provides balance to the apparatus 20 and facilitates easy use thereof.

The means and construction disclosed herein are by way of illustration and example, and comprise primarily the preferred and several alternative forms of putting the invention into effect. Although the drawings depict the preferred and several alternative embodiments of the invention, other embodiments are described within the preceding and following text.

One skilled in the art will appreciate that the disclosed apparatus may have a wide variety of different designs, shapes and configurations. Additionally, persons skilled in the art to which the invention pertains might consider the foregoing teachings to make a wide range of changes, modifications, other embodiments and alternative forms without departing from the scope and spirit of the invention.

It is, therefore, to be understood that the described embodiments are to be considered, in all aspects, only as illustrative and not restrictive.

The scope of this invention is not limited to the particular embodiments or specific features shown herein. To the contrary, the inventor claims the invention in all of its various forms, including all equivalents, modifications and alternative embodiments that fall within the legitimate and valid scope of the appended claims, including as appropriately interpreted under the Doctrine Of Equivalents.

### Industrial Applicability

The apparatus taught herein could be used within dental and medical profession environments, such as by licensed dentists, medical doctors, surgeons, dental hygienists, dental assistants, trained technicians, personnel of medical clinics, hospitals and the like, and other persons with the proper governmental authorization. This invention provides simple, safe, effective, easily used hand-held apparatus for: removing dental calculus, scale, tartar and other undesirable materials from a tooth; debriding tissue; correcting tissue abnormalities; and performing other surgeries and dental operations. Traditional or nontraditional tool tips or instruments may be attached thereto. Traditional or nontraditional means for powering the apparatus may also be used.

Although the invention could have a wide range of applications, the invention has a special application as a dental scaler apparatus. The present invention permits such procedure to be accomplished in areas of extreme limited access with no or very limited contact with adjacent teeth, bone and soft tissue.

I claim:

1. An improved, electrically-powered, hand-held, piezoelectric dental scaler apparatus for removing dental calculus, scale, tartar or undesirable material, debriding, abrading, cutting, sculpting or correcting abnormalities, or performing surgical or dental operations on a tooth, bone or tissue, said apparatus capable of being operatively connected to an electric control module or device which can provide selective oscillating electrical charges to said apparatus, said apparatus capable of being operatively connected to a removable scaler tool or other instrument which has a tip and a tool coupling end, said apparatus comprising: an operative handle assembly defining a hand piece, said handle assembly having internal operational components and external housing components, said internal operational components being defined by
(a) a segmented bar or tube having a front mass portion and a rear or back mass portion, said front mass portion having a distal end to which the coupling end of the removable scaler tool or other instrument may be removably attached, said front mass portion having an opposed proximal end,
(b) said back mass portion having an inertia resistance greater than an inertia resistance of said front mass, said back mass portion having a first end capable of being operatively and removably secured to said proximal end of said front mass portion, said back mass portion having an opposed second end, said back mass portion having an elongated shaft member positioned intermediate between said first end and said second end,
(c) one or more piezoelectric ceramic discs or disks capable of being operatively connected to the electric control module or device and to the oscillating electrical charge thereof, said ceramic discs capable of expanding and contracting or returning to a latent non-electrically charged state in an oscillating manner with a variable, selectable, maximum or limited stroke when operatively connected to the oscillating electrical charge, said ceramic discs being juxtaposed between said front mass portion and at least a portion of said back mass portion, said ceramic discs having a bore hole therein through which said elongated shaft member of said back mass portion may be inserted, said elongated shaft member of said back mass portion having a length capable of being stretched and further elongated which is substantially longer than a combined thickness of said ceramic discs,
(d) a spacer positioned between said ceramic discs and said back mass portion or positioned between said ceramic discs and said front mass portion to accommodate substantial length of said elongated shaft member, operative attachment of said back mass portion to said front mass portion causing said ceramic discs to be compressed between said spacer and said front mass portion or be compressed between said spacer and said back mass portion,
said external housing components including a segmented handle having a front portion and a rear portion which are capable of being joined together or separated, said handle having a cavity or compartment therein of sufficient size and structure to accommodate placement of said internal operational components therein, said handle further including means for insulating at least a portion of vibrations of said internal operational components.

2. The apparatus of claim 1, wherein said front mass portion and said back mass portion of said segmented are provided with aligned, co-linear, longitudinal suction or application bore holes therein through which a fluid or gas may pass.

3. An improved, electrically-powered, hand-held, piezoelectric dental scaler apparatus for removing dental calculus, scale, tartar or undesirable material, debriding, abrading, cutting, sculpting or correcting abnormalities, or performing surgical or dental operations on a tooth, bone or tissue, said apparatus capable of being operatively connected to an electric control module or device which can provide selective oscillating electrical charges to said apparatus, said apparatus capable of being operatively connected to a removable scaler tool or other instrument which has a tip and a tool coupling end, said apparatus comprising: an operative handle assembly defining a hand piece, said handle assembly having internal operational components and external housing components, said internal operational components being defined by
(a) a segmented bar or tube having a front mass portion and a rear or back mass portion, said front mass portion having a distal end to which the coupling end of the removable scaler tool or other instrument may be removably attached, said front mass portion having an opposed proximal end,
(b) said back mass portion having an inertia resistance greater than an inertia resistance of said front mass, said back mass portion having a first end capable of being operatively and removably secured to said proximal end of said front mass portion, said back mass portion having an opposed second end, said back mass portion having an elongated shaft member positioned intermediate between said first end and said second end,
(c) one or more piezoelectric ceramic discs or disks capable of being operatively connected to the electric control module or device and to the oscillating electrical charge thereof, said ceramic discs capable of expanding and contracting or returning to a latent non-electrically charged state in an oscillating manner with a variable, selectable, maximum or limited stroke when operatively connected to the oscillating electrical charge, said ceramic discs being juxtaposed between said front mass portion and at least a portion of said back mass portion, said ceramic discs having a bore hole therein through which said elongated shaft member of said back mass portion may be inserted, said elongated shaft member of said back mass portion having a length capable of being stretched and further elongated which is substantially longer than a combined thickness of said ceramic discs, said back mass portion having a bore hole therein through which said elongated shaft member may pass, said back mass portion further including a compression nut, operative attachment of said compression nut to said elongated shaft member at or near said second end of said back mass portion capable of causing said ceramic discs to be compressed between said back mass portion and said front mass portion, expansion, stretching or elongation of said elongated shaft member being distributed along at least a length that spans between said front mass portion and said compression nut,
said external housing components including a segmented handle having a front portion and a rear portion which are capable of being joined together or separated, said handle having a cavity or compartment therein of sufficient size and structure to accommodate placement of said internal operational components therein, said handle further including means for insulating at least a portion of vibrations of said internal operational components.

4. The apparatus of claim 3, wherein said elongated shaft member generally comprises a tensile bolt or tube, a forward, leading and distal end of said tensile bolt being mechanically secured to said proximal end of said front mass portion.

5. The apparatus of claim 4, wherein said tensile bolt has a terminal, rearward or trailing end which is threaded to received mated and threaded said compression nut, said compression nut being removably secured to said rearward end of said tensile bolt, rotation of said compression nut onto said rearward end of said tensile bolt exerting primarily compression force and little or no shear or torsional forces upon said ceramic discs.

6. The apparatus of claim 4, wherein said back mass portion further defines a hollow cylindrical tube having a bore hole or core opening located along an entire length thereof and which is capable of receiving said tensile bolt, said tensile bolt having a rearward, trailing and proximal end which passes through said bore hole or core opening, said hollow cylindrical tube generally defining an inertia resistant back mass.

7. The apparatus of claim 3, wherein said elongated shaft member is centrally positioned within said handle assembly.

8. The apparatus of claim 6, wherein the tensile bolt is manufactured from a material that is chemically, structurally or characteristically different from material used in manufacture of said hollow cylindrical tube that generally defines a majority of weight of said inertia-resistant back mass.

9. The apparatus of claim 8, wherein said tensile bolt is manufactured from titanium or a titanium alloy.

10. The apparatus of claim 8, wherein said hollow cylindrical tube of said back mass portion is manufactured from a material that is substantially heavier or denser than material from which said tensile bolt is manufactured.
